(19) United States
(12) Patent Application Publication
(10) Pub. No.: US 2005/0287441 A1
(43) Pub. Date: Dec. 29, 2005

(54) Lithium polymer electrolyte batteries and methods of making

(76) Inventors: Stefano Passerini, Rome (IT); Wesley A. Henderson, Annapolis, MD (US); Joon-Ho Shin, Umea (SE); Fabrizio Alessandrini, Tivoli (IT)

Correspondence Address: MICHAEL BEST & FRIEDRICH, LLP, ONE SOUTH PINCKNEY STREET, P O BOX 1806, MADISON, WI, 53701, US

(21) Appl. No.: 11/165,608

(22) Filed: Jun. 23, 2005

Related U.S. Application Data
(60) Provisional application No. 60/582,318, filed on Jun. 23, 2004.

(51) Int. Cl. H01M 10/40

(52) U.S. Cl. 429/307; 429/317

(57) ABSTRACT

This invention is a new solid polymer ionically-conducting electrolyte material or composition (SPE) in which the mobile ions include, but are not limited to the lithium ion. SPEs of this invention are formed from the combination of three component materials comprising: (1) an ionic liquid as defined herein, (2) a lithium salt and (3) a polyalkene oxide or polyether material. The invention is useable with numerous types of electrochemical devices, especially rechargeable batteries.

### CROSS-REFERENCE TO RELATED APPLICATIONS

This application claims priority to Provisional patent application No. 60/582318, filed Jun. 23, 2004, which is incorporated by reference herein in its entirety.

### BACKGROUND OF THE INVENTION

Room temperature ionic liquids (RTILs) i.e., salts which are liquid or molten at about room temperature, are gaining notoriety for their use as ‘green solvents’. But they are also finding wide application in electrolytes for electrochemical mechanical actuators, electrochromic windows and numerical displays with conducting polymers, dye-sensitized solar cells, light-emitting electrochemical cells and other devices. This novel class of materials is revolutionizing many fields of scientific and technological interest. The battery field is no exception.

Cellular phones, laptop computers, digital cameras and other portable electronic devices heap many demands upon the batteries which power them. Long operation times and rapid response displays mean high energy densities and high power. Nickel-cadmium (NiCd) and nickel metal hydride batteries have been principally used to date. These are now being replaced by Li-Ion batteries—batteries which utilize carbon intercalation anodes and liquid or polymer-liquid ‘gel’ electrolytes. Even higher energy densities may be obtained with Li-Metal batteries i.e., by replacing the carbon anodes with metallic Li. Metallic lithium, however, is typically not compatible with the liquid solvents used in Li-Ion battery electrolytes. The presence of liquids requires special battery pack sealing to prevent leakage and volatiles can lead to explosions. Reactions of liquid solvents with Li metal also may result in poor battery performance. It is therefore desirable to have all-solid-state batteries in which the anode, electrolyte and cathode are flexible films, i.e., lithium-metal-polymer, LMP, batteries, for ease of assembly, versatility in battery shape/design, safety, and improved performance.

High power is often limited by the electrolyte's ionic conductivity. Many applications require Li⁺ cation conductivities >10⁻³ S cm⁻¹. Portable electronic devices often operate at or near ambient temperature ˜25° C., however, making this requirement difficult to meet. Poly(ethylene oxide) or PEO, HO—(CH₂CH₂O)ₙ—H, was the first polymer used as a solid solvent for lithium salts, LiX, to form polymer electrolytes. PEO, with flexible ethoxy segments and the strong donor character of the ether oxygens (EOs), readily solvates Li⁺ cations. Numerous PEO—LiX crystalline phases form, but ionic conductivity has been shown to predominate in amorphous materials. Unfortunately, the conductivity of PEO—LiX electrolytes is typically 10⁻⁵ S cm⁻¹ or lower at 25° C. A wide range of amorphous polymers have been explored to replace PEO and optimize the room temperature ionic conductivity, but an upper limit of about 10⁻⁴ S cm⁻¹ has been reached. Additionally, a tradeoff often exists between higher ionic conductivity and a reduction in mechanical properties for such electrolytes.

### SUMMARY OF THE INVENTION

Briefly, in one aspect, this invention is a new kind of solid, polymeric ionically conducting electrolyte material or composition of matter, in which the mobile ions include, but are not limited to the lithium ion. The solid polymeric electrolyte material of this invention is formed from the combination of three component materials comprising: (1) an ionic liquid, (2) a lithium salt and (3) a polyalkene oxide or polyether material. Each of these must be included as “reactant materials” to form a true, solvent-free solid polymer electrolyte. Other components can be introduced to activate or enhance specific properties, such as inert fillers to improve the mechanical stability, SEI formation additives to allow the formation of the passive layer on carbon anodes for lithium-ion batteries. Other components will be readily apparent to one skilled in this art in view of the present disclosure. This electrolyte materially and substantially enhances the performance and safety characteristics of all solid-state LMP batteries and related electrochemical devices.

The salt is formed with at least one cation and one anion. In the preferred composition the cation is lithium and the anion is TFSI, BETI or triflate (CF₃SO₃⁻), AsF₆⁻, BF₄⁻, PF₆⁻, alkyl fluoro phosphates, or Li bis(oxalato)borate, LiBOB or “BOB.” TFSI, BETI and BOB are the preferred anions.

The polymer is any polymer able to coordinate, solvate, mobilize or dissolve a lithium salt (or other metal salts if different metal cation conduction is wanted) generally by the coordination of the lithium cation. Preferably the polymer is a polyamine or, even better, a polyether (including partially fluorinated polyethers) and especially PEO.

The IL is generally selected from the group consisting of N,N-dialkylpyrrolidinium bis(trifluoromethanesulfonyl)imide (PYR_{x,y}TFSI) and related salts. The ILs of this invention can be represented by the structure: 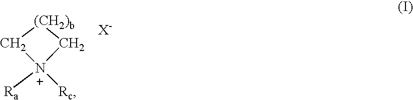
wherein X⁻ is preferably 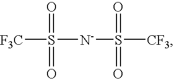
Wherein Rₐ and R_{c} are separately and independently branched or linear alkyl groups which are the same or different (Rₐ and R_{c} may together form a cycloalkyl structure), “a” and “c” independently having a value in the range of about 1 to 10 and “b” has a value in the range of 2-4. The Formula I structure might be generally referred to as N,N di lower alkyl cycloalkylindium TFSI in its preferred embodiment.

Particularly preferred ILs for practice of this invention are:

N-methyl-N-propylpyrrolidinium bis(trifluoromethanesulfonyl)imide
PYR_{1,3}TFSI

N-methyl-N buthylpyrrolidinium bis(trifluoromethanesulfonyl)imide
PYR_{1,4}TFSI
and

N-methyl-N-propylpiperidinium bis(trifluoromethanesulfonyl)imide,
PIP_{1,3}TFSI.
The subscripts refer to the number of carbon atoms in the groups attached to the N⁺ nitrogen.

A BETI IL as derived from lithium bis(perfluoroethylsulfonyl)imide, LiN(SO₂—CF₂—CF₃)₂, also is preferred.

The preferred example of the electrolyte is PYR_{1,3}TFSI—LiTFSI—PEO, although PYR_{1,4}TFSI provides good low temperature performance. The molar composition of the electrolyte x PYR_{1,3}TFSI-y LiTFSI—P(EO)_{z} with x=0.5 to 3, y=1, z=8 to 20.

In another aspect, the present invention is a solvent-free electrochemical device comprising:
an anode comprising lithium, (e.g., including lithium foil, lithium ion, or lithium alloys), or a composite anode comprising the anode material, carbon and the polymer electrolyte of this invention acting as an ionic conductor and binder (the binder can be other materials), the polymer electrolyte comprising an ionic liquid discussed above;
polyalkylene oxide, e.g., PEO having a molecular weight in the 1×10⁴-1×10⁸ range;
a lithium salt; and
a composite cathode.
More specifically, an electrochemical device of this invention comprises:
an anode comprising lithium metal, e.g., lithium foil, or a composite anode comprising the anode material, carbon and the polymer electrolyte of this invention acting as an ionic conductor and binder (the binder can be other materials), the polymer electrolyte further comprising an ionic liquidand a lithium salt as discussed above;
a solvent-free polymer electrolyte comprising polyalkylene oxide, e.g., PEO having a molecular weight in the 1×10⁴-1×10⁸ range; and
a composite cathode comprising the cathode material, carbon and the polymer electrolyte of this invention acting as an ionic conductor and binder (the binder can be other materials), the polymer electrolyte further comprising an ionic liquid discussed above.

The IL, generally speaking, will have its anion in common with the lithium salt, (although mixed anions can be used). Cathode chemistries can include essentially any of commonly used cathode materials, for example MnO₂, LiFePO₄, Ag₂V₄O₁₁ and V₂O₅. Other cathode chemistries will be readily apparent to one skilled in this art in view of the present disclosure. Anode chemistries can include essentially any of commonly used anode materials, for example lithium metal or lithium foil, or Li-ion anodes including graphite, Li₄Ti₅O₁₂, and lithium alloys. Other anode chemistries will be readily apparent to one skilled in this art in view of the present disclosure.

### BRIEF DESCRIPTION OF THE DRAWINGS

FIG. 1 illustrates schematically a solvent-free method for processing polymer electrolytes showing the steps of:
preparation in water-free controlled environment (dry-room)
drying and sieving of high purity material
homogenizing of components
melting and blowing of mixed powders
calendaring of extruded tapes (50-100 μm)

FIG. 2 shows further details of the process of FIG. 1; the entire process being performed in a dry room, i.e., relative humidity of <1%;

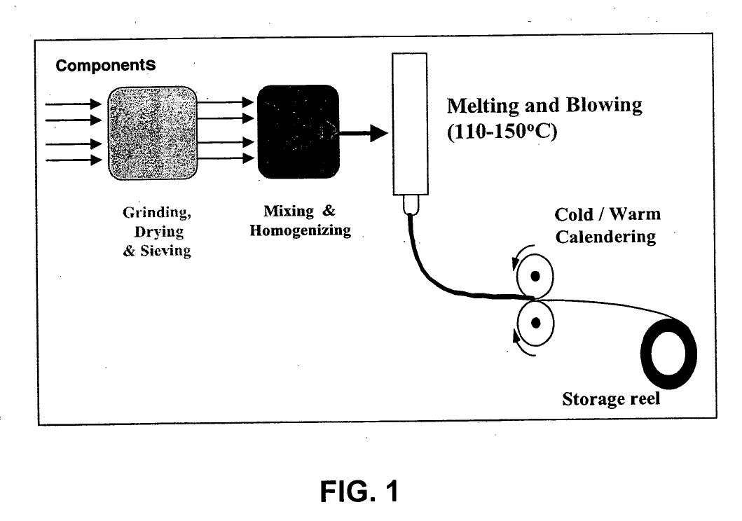

FIG. 3 sets forth, schematically, a synthetic route for an ionic liquid component of the present invention.

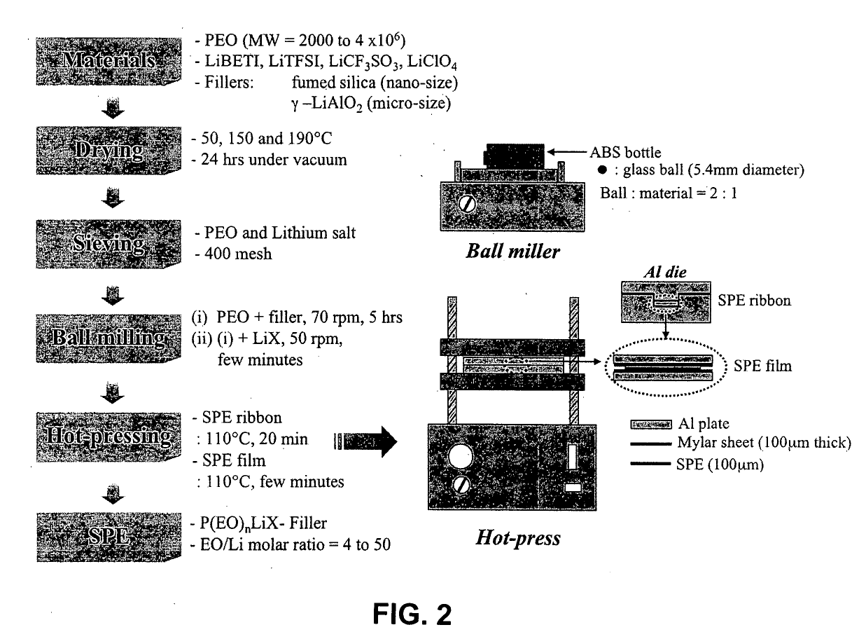

FIG. 4 is a photograph of a representative vacuum-sealed, laminated solid-state electrochemical cell of the present invention. The cell shown has good polymer electrolyte properties

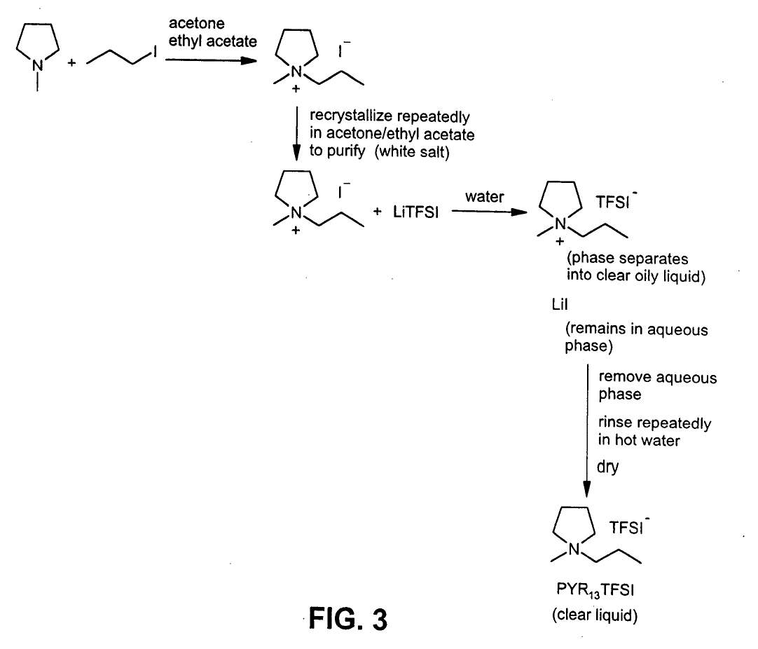

FIG. 5 shows discharge profiles vs. delivered capacity of a Li/P(EO)₂₀LiTFSI-80 wt % PYR_{1,3}TFSI/LiFePO₄ cell performed at 40° C. Charge and discharge (C/20) current density: 0.039 mA/cm², Cut-off voltage: 2<V<4.

FIG. 6 shows rate and cycling performance of a Li/P(EO)₂₀LiTFSI-80 wt % PYR_{1,3}TFSI/LiFePO₄ cell performed at 40° C. The cell is repetitively discharged at C/20, C/10, C/5, C/3, C and 2 C rates. Charge (C/20) current density: 0.039 mA/cm², Cut-off voltage: 2<V<4.

FIG. 7 shows voltage profiles vs. delivered capacity of a Li/P(EO)₂₀LiTFSI-80 wt % PYR_{1,3}TFSI/LiFePO₄ cell discharged with different rates at 40° C. Charge (C/20) current density: 0.039 mA/cm², cut-off voltage: 2<V<4.

FIG. 8 shows cell Voltage (V) profile vs. delivered capacity (Mah/g) of a Li/P(EO)₂₀LiTFSI-80% PYR_{1,3}TFSI/LiFePO₄ cell performing the pulse test to 40° C. Pulse current density: 1.30 mA/cm .

Test Schedule:

1. Pulse at 1.3 mA/cm² (3 C), for 10 seconds.
2. Rest on open circuit for 15 sec.
3. Repeat 1 and 2 three times more, for a total of 4 pulses.
4. Open circuit for 30 minutes.
5. Repeat steps 1-4, as above until rest voltage in step 4 does not recover above 3 V.
6. Charge at constant current (C/3) up to 4 V and then at constant voltage until i_{ch} (charge current)≦C/10.
7. Repeat steps 1-6.

FIG. 9 is a ternary composition diagram, in weight %, of ion coordinating polymer, lithium salt (Li⁺x⁻) and ionic liquid (Q⁺Y⁻) (X⁻ and Y⁻ may be the same or different). Compositions of the present invention are designated by the quadrilateral indicated SPE with the most preferred compositions shown by square 1.

### DETAILED DESCRIPTION OF THE INVENTION

In recent years ionic liquids, ILs, with organic cations have been suggested for electrolyte applications. Unlike conventional liquid solvents, ILs have negligible vapor pressures. The absence of volatiles greatly improves the safety characteristics of a battery. Some ILs have conductivities of 10⁻² S cm⁻¹ or higher at 25° C. A lithium battery, however, requires Li⁺ cations to be transported between the anode and cathode. The ILs (Q⁺Y⁻) must therefore incorporate a suitable LiX salt to be a useful Li. battery electrolyte. It is preferred to have a SPE material. The ILs may then be incorporated into a flexible, thin membrane to form a battery electrolyte.

The IL used, in one aspect, is N-methyl-N-propylpyrrolidinium bis(trifluoromethanesulfonyl)imide (PYR_{1,3}TFSI). The TFSI anion has extensive charge delocalization across the SO₂—N—SO₂ segment and two low energy conformations indicating that the anion is highly flexible. Electrolytes were prepared consisting of P(EO)₂₀LiTFSI+x wt % PYR_{1,3}TFSI (x=0, 30, 50, 100 and 150):

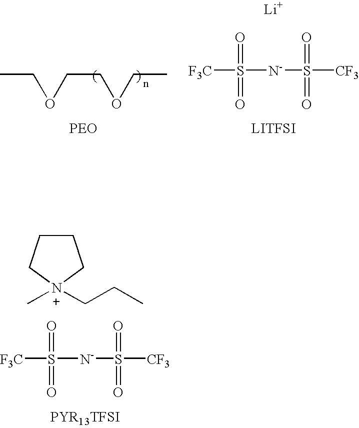

The wt % IL is relative to the amount of PEO with 30 and 150 wt % corresponding to a PYR_{1,3}⁺/Li⁺ mole ratio of approximately 0.66 and 3.24, respectively. Large amounts of IL may thus be used to prepare free-standing solid polymer electrolyte membranes.

It has been found that the addition of up to about 30 wt % IL results in an increase of an order of magnitude or more of ionic conductivity for the P(EO)₂₀LiTFSI system at lower temperatures reaching 10⁻⁴ S cm⁻¹ at 30° C. The conductivity rises further with increasing amounts of IL approaching 10⁻³ S cm⁻¹ at 30° C. with 150 wt % IL. Note that this value is close to that for the pure IL. Typically, the addition of polymers to liquid electrolytes to form ‘gels’ results in a significant drop in the ionic conductivity. This is also true of rubbery polymer-in-salt materials.

It has been found that it is not the overall ionic conductivity of the electrolyte which is critical, but rather the conductivity of the reactive species (e.g., Li⁺ cations). The discharge of Li-Metal batteries occurs by liberating electrons at the anode and forming Li⁺ cations. The electrons travel through the current collectors to the cathode creating an electric current from which useful work may be done. The Li⁺ cations travel through the electrolyte to the cathode where they react with the active material:
Li(s)→nLi⁺+ne⁻
nLi⁺+V₂O₅+ne⁻→LiₙV₂O₅

Recharging of secondary batteries occurs by reversing the process. The reaction thus requires Li⁺ cations to move between the active materials at the electrodes. The other ions in the electrolyte (i.e., PYR_{1,3}⁺ and TFSI⁻), however, are also mobile, but do not participate in the reaction. These ions may thus polarize a cell when current is passed.

Ideally, all of the charge would be carried by Li⁺ cations giving a Li transference number of unity, T_{Li}=1, where T_{Li} is the fraction of the current carried by Li. The Li⁺ cation conductivity is obtained from:
σ_{Li}=T_{Li}(σ_{TOT}).

In practice, most cations have much lower values than unity due to mobile counter anions. The PEO—LiX-IL electrolytes also contain additional cations and anions. For the P(EO)₂₀LiTFSI electrolyte (0 wt % IL), a T_{Li}=0.31 value indicates that a large fraction of the current is actually from TFSI⁻ anionic transport despite the significant difference in ion sizes. This is due to the strong solvation of the Li⁺ cations by multiple polymer EOs. T_{Li} values similar to this or lower for PEO—LiTFSI electrolytes have been previously reported from diffusion measurements. One might expect that the addition of an IL to the electrolytes would significantly decrease the T_{Li} values even further. Surprisingly this does not seem to be the case. Instead, the T_{Li} values decrease somewhat with increasing wt % IL, but a sharp decline is not observed.

In fact, the fraction of current carried by Li⁺ cations becomes larger than the calculated equal contribution values. This is surprising and suggests that a new Li⁺ cation transport mechanism becomes operative relative to an electrolyte not containing an IL of the present invention. The Li⁺ cations in an amorphous phase may become partially or fully coordinated by the TFSI⁻ anions freeing them from the traps created by strong polymer EO coordination. The addition of large quantities of IL to create PEO—LiX—IL solid polymer electrolytes, therefore, does not significantly increase the electrolyte polarization.

Differential scanning calorimetry (DSC) heating traces of samples equilibrated for several weeks at 0° C. indicate that the P(EO)₂₀LiTFSI electrolyte contains both crystalline PEO and a PEO—LiTFSI eutectic composition (with a P(EO)₆:LiTFSI crystalline phase). The weak T_{g} near −30° C. suggests that some amorphous phase is also present. Addition of IL results in the disappearance of the peak from the eutectic composition as well as a decrease in both the amount and Tₘ of the crystalline PEO. Note that with increasing wt % IL, there is a decreased fraction of PEO in each electrolyte. A strong T_{g} for an amorphous phase also becomes evident which moves to lower temperatures with increasing wt % IL. The pure IL (PYR_{1,3}TFSI) has a Tₘ of 12° C. After slowing cooling and heating the samples, an exothermic crystallization peak is found between −20 and 0° C. followed by an endothermic peak near 10° C. for the electrolytes with 100 and 150 wt % PYR_{1,3}TFSI. Thus, it appears that some of the PYR_{1,3}TFSI is able to crystallize after cooling the samples with the highest fraction of IL. This ‘excess’ IL has only a weak interaction with the remaining PEO, Li⁺ cations and TFSI⁻ anions. The PYR_{1,3}⁺/Li⁺ mole ratio for the 100 wt % IL electrolyte is 2.15. The ‘excess’ IL may therefore by anything over a PYR_{1,3}⁺/Li⁺ mole ration of 2. Despite this, homogeneous, free-standing solid electrolytes may be prepared with large amounts of IL.

It is important to verify the electrochemical stability of the electrolytes. Many ILs, such as those with 1,3-dialkylimidazolium cations, have acidic protons and thus may be too reactive to plate/strip Li metal reversibly during the charge/discharge of a battery. It has previously been shown that PYR_{xy}TFSI salts have a wide electrochemical stability window in excess of 5.5 V. Highly reversible Li plating/stripping is observed in a cell with the 100 wt % IL electrolyte.

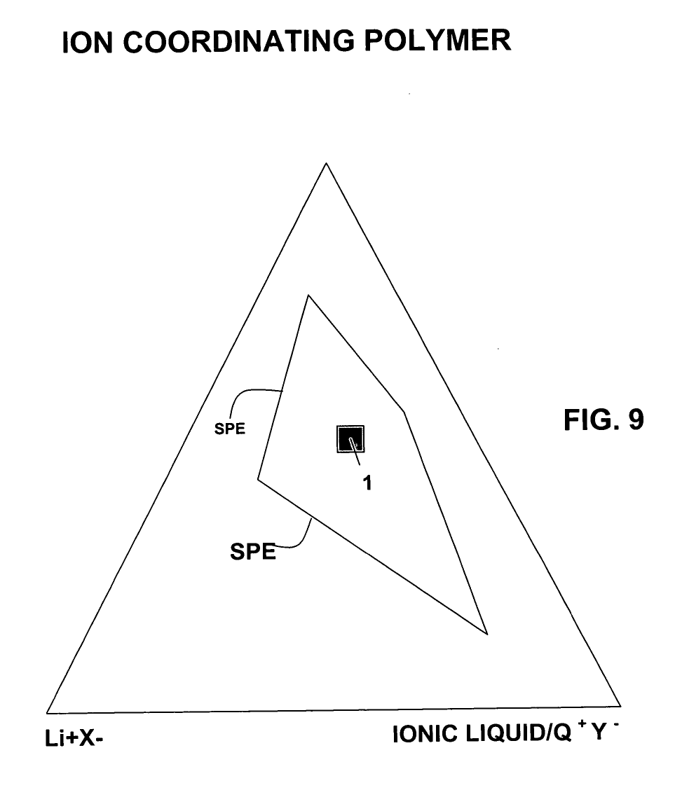

Ultimately, the goal is to obtain LMP batteries which are capable of operating at ambient and even subambient temperatures. The practical operating temperatures of LMP batteries must thus be lowered. The LMP battery discharge capacity at 20° C. and 60° C. using P(EO)₂₀LiTFSI+x wt % PYR_{1,3}TFSI (x=0 and 100) electrolytes for a C/20 discharge rate has been determined. At 60° C., the cell with the electrolyte containing 100 wt % IL shows a significantly improved performance over the one without IL (0 wt %) in spite of a lower T_{Li} value. This may be directly attributed to the higher conductivity of the former electrolyte. In fact, the discharge capacity at 60° C. is comparable to PEO—LiBETI (0 wt % IL) LMP batteries at 90° C. At 20° C., the cell with the electrolyte containing 0 wt % IL (Q⁺Y⁻ in FIG. 9) has a much lower capacity than at 60° C. This electrolyte, P(EO)₂₀LiTFSI, has an ionic conductivity at 20° C. which is amongst the highest known for solvent-free polymer electrolytes. The cells with electrolytes containing the IL also have lower capacities, but the capacity is 3-4 times greater than without the IL. Once again, this is attributed to the improved conductivity upon addition of IL. Note that the IL itself does not directly participate in the electrochemical reaction. The IL must therefore promote LI⁺ cation conductivity. SPEs of the present invention thus enable LMP batteries to operate at much lower temperatures and perhaps higher discharge rates.

Despite extensive research devoted to the development of new polymers and salts for solid polymer electrolyte applications, an upper limit to the total ionic conductivity of ˜10⁻⁴ S cm⁻¹ may have been reached at ambient temperature (with the Li⁺ cation conductivity only a fraction of this). This perceived limit may preclude the use of prior art electrolytes in batteries for portable electronic devices. However, the use of highly conductive, nonvolatile solid polymer electrolyte, e.g. as shown in FIG. 9, may overcome this perceived limit. The P(EO)₂₀LiTFSI+100 wt % PYR_{1,3}TFSI electrolyte has a Li⁺ conductivity ˜10⁻⁴ S cm⁻¹ at 20° C., whereas that of the IL free P(EO)₂₀LiTFSI electrolyte is only 2×10−6 S cm⁻¹. This is far superior to the performance of existing lithium polymer electrolytes and is in the neighborhood of a value necessary for room temperature battery operation. Thus, even with the PYR_{1,3}TFSI IL, which has a relatively low ionic conductivity relative to other ILs, the Li⁺ cation conductivity approaches that necessary target value. The electrolytes presented here thus have demonstrated a clear strategy for improving polymer electrolyte conductivity and thus dramatically lowering the device operating temperatures.

These new polymer electrolytes comprise high molecular weight PEO and two salts—one with Li⁺ cations and the other organic cations. The polymer, LiX salt and IL may all be varied. Increasing the LiX salt concentration may also increase the T_{Li} values thereby reducing the electrolyte concentration polarization. The presence of an IL evidently changes the Li⁺ cation transport mechanism within the membranes. This is a key point as the conductivity may therefore readily exceed the previous limits found for other (i.e., volatile solvent-free) ‘dry’ polymer electrolytes. SPE of this invention thus offer exciting possibilities for the long sought after low temperature use of solid polymer electrolytes in high energy LMP batteries.

### EXAMPLE 1

PEO, avg. Mᵥ ca. 4×10⁶ (Union Carbide), LiTFSI (3 M), V₂O₅ (Pechiney) and KJB carbon (Ketjen Black, Akzo Nobel) were dried under vacuum for 48 h at 50° C. for the PEO and 150° C. for the others. PYR_{1,3}I, was prepared by the reaction of 1-methylpyrrolidine with 1-iodopropane (Aldrich) in acetone/ethyl acetate. The PYR_{1,3}I salt was recrystallized several times in acetone/ethyl acetate. Combining LiTFSI and PYR_{1,3}I (1:1 mole ratio) in DI H₂O gave PYR_{1,3}TFSI. This was washed several times with hot DI H₂O and dried under vacuum at 80° C. for 24 h and then 100° C. for 24 h. The PYR_{1,3}TFSI salt is a clear liquid at room temperature. The materials were stored and handled in a dry room (<1% relative humidity, 20° C.). Polymer electrolytes and composite cathodes were prepared by mixing the desired amounts of PEO, LiTFSI and PYR_{1,3}TFSI and V₂O₅, 7% KJB, 17.7% PEO, 5.75% LiTFSI and 26.5% IL by weight). The mixtures were vacuum sealed in coffee bags and annealed at 90° C. for 24 h. Thin polymer electrolyte films were prepared by hot-pressing the mixtures. Composite cathode films were made by calendaring the mixture at room temperature. No solvent was used in the preparations.

Conductivity, T_{Li}, and galvanostatic measurements were performed on cells with Cu, Li and Li electrodes (4 cm², 1 cm², and 1 cm²), respectively, vacuum sealed in coffee bag envelopes and then laminated by hot-rolling at 100° C. All electrochemical and impedance measurements were performed using a Solarton electrochemical interface (ECI 1287), a Solartron frequency response analyzer (FRA 1260) and a Maccor battery cycler (Series 4000). All cells were thermally equilibrated for at least 1 h at the selected temperature prior to measurements. DSC measurements were performed on a TA Model 2910 differential scanning calorimeter. Samples were hermetically sealed in A1 pans. The pans were cooled to −140° C. at 10° C. min⁻¹, equilibrated and then heated to 200° C. at 10° C. min⁻¹.

### EXAMPLE 2

In accordance with the teaching of the present invention, an electrochemical cell of the following composition was assembled and discharged. Compositions of polymer electrolyte and LiFePO₄ composite cathode.

| | Electrolyte | Cathode |
|---|---|---|
| Component | composition (wt %) | composition (wt. %) |
| LiFePO₄ | | 43.0 |
| Carbon (KJB) | | 7.0 |
| PEO | 47.0 | 17.5 |
| LiTFSI | 15.3 | 5.0 |
| PYR_{1,3}TFSI | 37.7 | 27.5 |

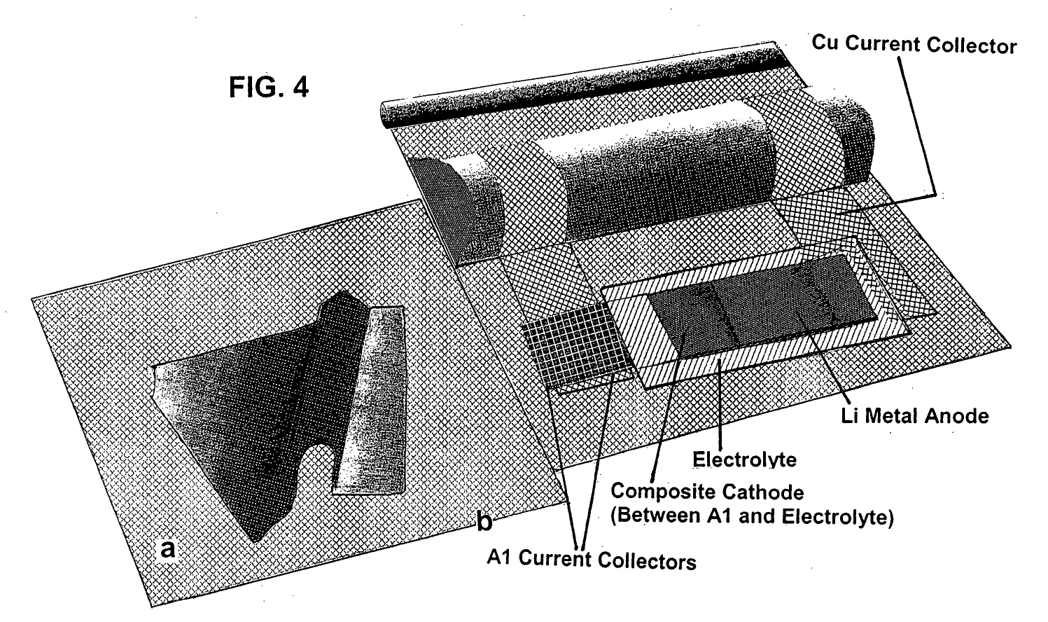

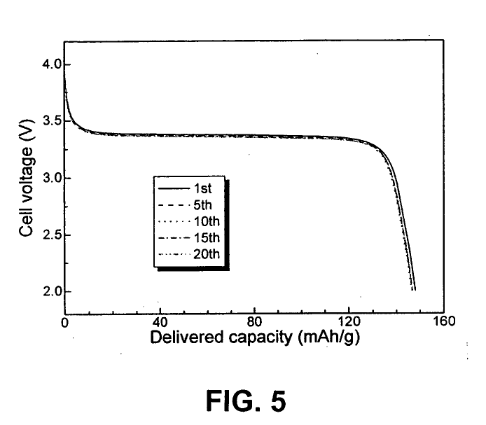

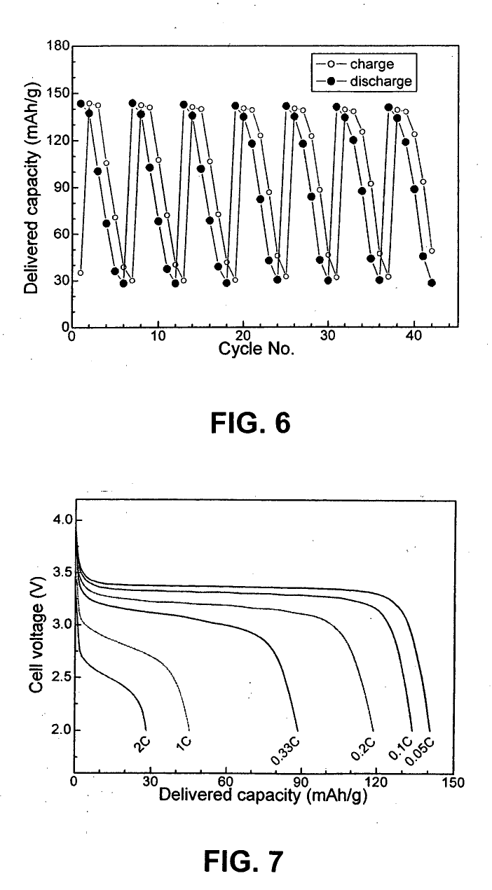

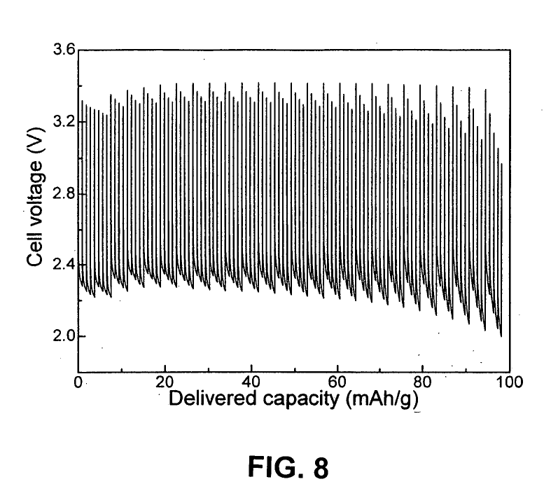

FIGS. 5, 6, 7 and 8 shown the performance of that electrochemical system.

It goes without saying that the present invention should not be limited by the above-described Examples. The present invention is useable with essentially any electrochemical device. Electrochemically powered medical devices, especially medical devices run at about body temperature, 37° C. are an especially preferred class. Implantable pacemarkers, defibrillators, drug pumps, tissue stimulators and neurological devices readily come to mind. Other applications include rechargeable lithium-ion batteries, rechargeable lithium metal batteries, primary batteries, lithium-based electrochemical devices which run at high temperature, e.g., 150° C., temperatures above body temperature (37° C.) and higher, and medical device batteries. All such devices are contemplated by this invention.

Applications also may include but are not limited to primary and secondary batteries, energy storage devices generally, and supercapacitors. Many other such devices will readily come to mind of one skilled in this art in view of this disclosure.

1. A solid polymer electrolyte for LMP electrochemical devices, comprising:
an ionic liquid selected from the group consisting of
N,N.di-alkyl pyrrolidinium bis(trifluoromethanesulfonyl)imide,
N,N,di-alkyl piperidinium bis(trifluoromethanesulfonyl)imide, and salts thereof;
polyalkylene oxide;
lithium salt.

2. A component of an LMP electrochemical device electrolyte, comprising: 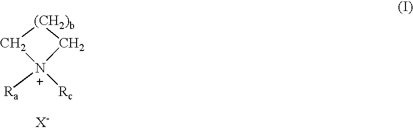
wherein rₐ and r_{c} are separately and independently linear or branched alkyl groups which are the same or different, “a” and “c” independently having a value in the range of about 1 to 10 and “b” has a value in the range of 2-4; and, X⁻ is an anion.

3. A solvent-free electrochemical device comprising
a lithium anode;
an electrolyte comprising:
polyalkene oxide having a molecular weight in the range of about 1×10⁴ to about 1×10⁸
a lithium salt;
and an ionic liquid of the structure: 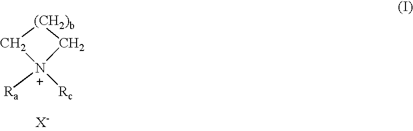
wherein rₐ and r_{c} are separately and independently linear or branched alkyl groups which are the same or different, “a” and “c” independently having a value in the range of about 1 to 10 and “b” has a value in the range of 2-4 and
X⁻ is an anion; and
a cathode.

4. A component according to claim 2 in which the anion (X⁻) is

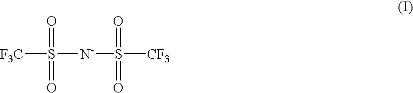

5. An electrolyte according to claim 1 in which N,N di alkyl is N methyl,N-propyl.

6. An electrolyte according to claim 1 in which the polyalkylene oxide is polyethylene oxide.

7. A component according to claim 2 in which X⁻ is selected from the group consisting of TFSI, BETI, triflate, ASF6⁻, BF4⁻, PF6⁻ alkyl fluoro-phosphates or BOB.

8. A solvent-free electrochemical device comprising:
a lithium anode;
a solid polymer electrolyte (SPE) comprising:
an ionic liquid;
a lithium salt; and
an ion coordinating polymer; and
a cathode.

9. An electrochemical device according to claim 8 in which the device is a rechargeable Li metal battery.

10. An electrochemical device according to claim 8 in which the device is a rechargeable Li ion battery.

11. An electrochemical device according to claim 8 wherein the cathode comprises LiFePO₄.

12. An electrochemical device according to claim 8 wherein the device is implantable and operates at body temperature.

13. An electrochemical device according to claim 8 wherein the device is a primary battery.

14. An electrochemical device according to claim 8 wherein the ion coordinating polymer comprises polyalkylene oxide.

15. An electrochemical device according to claim 14 wherein polyalkylene oxide comprises polyethylene oxide.
